(19) United States
(12) Patent Application Publication
(10) Pub. No.: US 2024/0110806 A1
(43) Pub. Date: Apr. 4, 2024

(54) TECHNIQUES FOR PROVIDING AN EXPERIENCE-FOCUSED NAVIGATION SESSION

(71) Applicant: GOOGLE LLC, Mountain View, CA (US)

(72) Inventors: Bruce Bahnsen; Yan Mayster

(21) Appl. No.: 17/638,013

(22) PCT Filed: Dec. 9, 2021
(86) PCT No.: PCT/US21/62537

§ 371 Date: Jun. 15, 2023

(51) Int. Cl. G01C 21/34; G01C 21/36; G06N 20/00

(52) U.S. Cl. CPC G01C 21/3484; G01C 21/3602; G06N 20/00

(57) ABSTRACT

A computing device may implement a method for providing an experience-focused navigation session. The method includes obtaining user data corresponding to a user of the computing device and a current location of the user. The method further includes determining a semantic mapping corresponding to the user based on one or more user preferences and a location history included in the user data, and determining a suggested experience-focused navigation session for the user based on the semantic mapping and the current location of the user. The suggested experience-focused navigation session includes an ordered list of one or more suggested points of interest. The method further includes automatically providing the suggested experience-focused navigation session to the user as an appointment on the computing device.

### FIELD OF THE DISCLOSURE

The present disclosure relates to navigation sessions and, more particularly, to techniques for providing an experience-focused navigation session to a user.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, many users request navigation directions that guide the user to a desired destination. A variety of software applications capable of executing on computers, smartphones, devices embedded in vehicles, etc. are available that can provide step-by-step navigation instructions. In many scenarios, a user may utilize these navigation applications to guide them to points of interest (POIs) that the user would otherwise be unable to locate. For example, users visiting new cities may have a particular POI they wish to visit during their trip, and may utilize one of the navigation applications to guide them to the particular POI.

However, in many instances, users are unaware of POIs that may interest them in particular locations, and/or these users may need additional activities to fill out their schedule during a particular period of time. Conventional navigation applications may provide users the opportunity to search more generally when an explicit POI is unknown, such as for an “Italian Restaurant” or a “Theater near me”, but these services still require the user to understand what they are looking for and to specify as such in order for the application to return a meaningful recommendation. Moreover, conventional navigation applications are typically unable to provide attendant/accompanying recommendations that provide a user with any kind of schedule for activities related to their search and/or interests. As a result, users are left on their own to search for activities that may interest them, creating an unfavorable user experience and occupying a significant amount of time and energy.

Thus, in general, conventional navigation applications fail to automatically provide users with POI recommendations that are specifically tailored to the user without any prompting, and any recommendations made by these conventional applications fail to consider the holistic nature of such recommendations.

### SUMMARY

Using the techniques of this disclosure, a user's computing device may automatically generate and notify a user of experience-focused navigation sessions that may seamlessly guide a user to multiple points of interest (POIs). An experience-focused navigation session may generally navigate a user to one or more POIs in a predetermined and/or dynamic order by providing sequential navigation directions for the user to follow. Each of the experience-focused navigation sessions may be created dynamically such that they are completely customized to each user, and/or the experience-focused navigation sessions may have an open agenda for a given timeframe in a particular location. In either case, an experience-focused navigation session can be created and/or enhanced by the user responding to a few questions generated by the present techniques. For example, a system of the present disclosure may generate and/or utilize a chatbot interface to obtain the information from the user in an intuitive way. Regardless, user input may serve as feedback from which the systems of the present disclosure may learn to improve experience-focused navigation sessions and recommendations for the experience-focused navigation sessions for the user and other users utilizing these techniques.

Generally, a POI may be a landmark, a business, a street, a road, a highway, a town, a public transportation hub, a body of water, a shopping center, a department store, a neighborhood, a building, a home, a restaurant, and/or any other suitable location or some combination thereof. The POIs referenced herein may be proximate to the user's current location (e.g., within several miles), and may be identified and output to a user in a suggested experience as a result of user preferences (e.g., preferred restaurants, daytime activities, nighttime activities, etc.), and/or any other suitable determination criteria. For example, a suggested experience may include hiking along a popular trail and dinner at an Italian restaurant as a result of a user's explicit and/or inferred interest in both activities.

The user's location history may be used to determine which POIs a user has liked in the past, in order to suggest similar ones for a new location. The systems of the present disclosure may infer from signals, such as future calendar events or real-time GLS tracks, whether the user is in their hometown or travelling. If the user is travelling, the systems of the present disclosure may further consider the purpose of travel (e.g., business/vacation/family reunion/etc.) and whether or not it is to a new destination or one they have been to before. In the case of a new city, the systems of the present disclosure may suggest tourist areas, like Pike Place Market and the Space Needle for Seattle. However, the systems of the present disclosure may skip such tourist areas for locations the user has been to before.

For example, a user might prefer a quiet experience or alternately a very crowded, bustling sequence of destinations. The systems of the present disclosure can meet any of these desires by accessing relevant historical and real-time information for each individual POI to generate an experience-focused navigation session that is tailored for each individual user.

In certain aspects, the systems of the present disclosure may be integrated with a calendar application so that the commitments a user is planning can be known in advance. A user may have one or more destinations to visit on a particular day. In this case, the systems of the present disclosure may dynamically generate an experience-focused navigation session by filling in one or more time slots with other compatible destinations. For example, a user might be skiing during the day, and watching a show at night with a gap in between. To fill this gap, the systems of the present disclosure may recommend a restaurant that matches the overall vibe of the user's activities and that fits into the time and space constraints already established by the user-selected destinations.

These calendar entries, which are suggestions from the systems of the present disclosure, may then be surfaced as “faux commitments” shown in faded color and/or otherwise indicated on the calendar application of the user's computing device. Such entries may be accepted or declined, per the user's interest in the proposal, and these acceptances and/or declinations may be used by the systems of the present disclosure to refine subsequent recommendations. In this manner, the user may be introduced to experience-focused navigation sessions passively as no user interaction is required other than an up-to-date calendar and an accept/decline/ignore interface response (or lack thereof).

Moreover, for any given experience-focused navigation session accepted by the user, the systems of the present disclosure may track the user's progress through that experience-focused navigation session (per a user opt-in) and derive various indications of satisfaction with the experience-focused navigation session based on the user's behavior. For example, if a user has followed a recommended experience, the system may ask the user to explicitly rate (e.g., on a scale of 1 to 10) the experience-focused navigation session on one or more dimensions, such as cost, quality, entertainment value, appropriateness, etc. The systems of the present disclosure may utilize these rankings to highlight good experience-focused navigation sessions so that they may be recommended to other users.

In certain instances, the systems of the present disclosure may also deduce implicit signals of satisfaction based on several behaviors, including: (i) not visiting one or more of the one or more suggested points of interest, (ii) visiting an alternative point of interest instead of one of the one or more suggested points of interest, or (iii) receiving a denial indication from the user of the suggested experience-focused navigation session. The systems of the present disclosure may also attempt to identify historical “ad hoc” experience-focused navigation sessions and request that the user rank them in order to determine whether or not the ad hoc experience-focused navigation session should be a formally recognized/recommended experience-focused navigation session.

Still further, the experience-focused navigation sessions can be tagged so that the type of experience-focused navigation session (e.g., party, relaxing, educational, etc.) can be discovered by other users. The systems of the present disclosure may also enable experience-focused navigation sessions to be shared on social media, sent to other users, commented on, etc. to increase their overall popularity. Additionally, or alternatively, merchants/venues/etc. may collaborate to produce their experience-focused navigation sessions, and may include some discounts and other cost savings as a result of visiting their POIs as part of the experience-focused navigation session. For example, a ticket at a specific venue may have a QR code, which when scanned by a user, opens the navigation application with a specific “recommended” experience-focused navigation session with the next stop offering you a 20% discount in the next 3 hours, and visiting the subsequent stop may result in a 25% discount at the POI.

In this manner, aspects of the present disclosure provide a technical solution to the problem of erroneous and/or otherwise low-quality recommendations from navigation/maps software by automatically providing experience-focused navigation sessions for users. Conventional systems may provide directions to a single POI at the request of a user, and at best may be capable of providing directions among multiple POIs, but are typically incapable of understanding why such POIs may be indicated together. Consequently, conventional systems are unable to budget appropriate amounts of time for each indicated POI, suggest and/or otherwise determine potential replacement POIs in case of a contingency, and generally lack the ability to treat the input sequence of visits as a holistic experience. As a result, conventional systems typically require users to independently determine POIs and to interact with the navigation/mapping application multiple times to receive directions from one POI to the next. By contrast, the experience-focused navigation sessions of the present disclosure eliminate the need for repeated, tedious interactions with a navigation application by providing a seamless user experience to reliably travel from one point of interest to another on a timeframe that ensures an enjoyable experience at each location.

One example embodiment of the techniques of this disclosure is a method for providing an experience-focused navigation session. The method includes obtaining, at one or more processors of the computing device, user data corresponding to a user of the computing device and a current location of the user; determining, by the one or more processors, a semantic mapping corresponding to the user based on one or more user preferences and a location history included in the user data; determining, by the one or more processors, a suggested experience-focused navigation session for the user based on the semantic mapping and the current location of the user, wherein the suggested experience-focused navigation session includes an ordered list of one or more suggested points of interest; and automatically providing, by the one or more processors, the suggested experience-focused navigation session to the user as an appointment on the computing device.

Another example embodiment is a computing device for providing an experience-focused navigation session. The computing device includes one or more processors; and a non-transitory computer-readable memory coupled to the one or more processors and storing instructions thereon that, when executed by the one or more processors, cause the computing device to: obtain user data corresponding to a user of the computing device and a current location of the user, determine a semantic mapping corresponding to the user based on one or more user preferences and a location history included in the user data, determine a suggested experience-focused navigation session for the user based on the semantic mapping and the current location of the user, wherein the suggested experience-focused navigation session includes an ordered list of one or more suggested points of interest, and automatically provide the suggested experience-focused navigation session to the user as a notification on the computing device.

Yet another example embodiment is a tangible, non-transitory computer-readable medium storing instructions for providing an experience-focused navigation session, that when executed by one or more processors cause the one or more processors to: obtain user data corresponding to a user of the computing device and a current location of the user; determine a semantic mapping corresponding to the user based on one or more user preferences and a location history included in the user data; determine a suggested experience-focused navigation session for the user based on the semantic mapping and the current location of the user, wherein the suggested experience-focused navigation session includes an ordered list of one or more suggested points of interest; and automatically provide the suggested experience-focused navigation session to the user as a notification on the computing device.

Still another example embodiment of the techniques of this disclosure is a method for navigating a user to a point of interest. The method may comprise obtaining, at one or more processors of a computing device, user data corresponding to a user of the computing device and a current location of the user; determining, by one or more processors, a semantic mapping corresponding to the user based on one or more user preferences and a location history included in the user data; and determining, by the one or more processors, a suggested navigation session for the user based on the semantic mapping and the current location of the user. The suggested navigation session may include an ordered list of one or more suggested points of interest. The method may include providing, by the one or more processors, the suggested navigation session to the user, e.g., as an appointment on the computing device. The method may include receiving a user selection of the suggested navigation session, and navigating the user to the one or more suggested points of interest of the suggested navigation session.

### BRIEF DESCRIPTION OF THE DRAWINGS

FIG. 1 is a block diagram of an example communication system in which techniques for providing an experience-focused navigation session can be implemented;

FIG. 2 illustrates an example transition between a navigation display and a calendar application display corresponding to suggested experience-focused navigation sessions;

FIG. 3 illustrates an example transition between an appointment notification generated using the techniques of the present disclosure and an experience-focused navigation session display using a navigation application;

FIGS. 4A-4C illustrate example navigation application displays requesting various user feedback to enhance and/or otherwise adjust the experience-focused navigation sessions;

FIG. 5 illustrates an example calendar application display as a result of a user scanning an encoded indicia;

FIG. 6 illustrates an example navigation application display as a result of a user scanning an encoded indicia;

FIG. 7 is a flow diagram of an example method for providing an experience-focused navigation session, which can be implemented in a computing device, such as the computing device of FIG. 1.

### DETAILED DESCRIPTION

### Overview

As referenced herein, an “experience” (also referenced herein as a “suggested experience” and an “experience-focused navigation session”) may generally refer to a sequence of POIs that logically fit together into an extended navigation session. More specifically, “experiences” may be recommended to users or requested by users, and directions to each of the POIs may be displayed to a user in a navigation application as a unit, such that a user may receive turn-by-turn directions to each POI as part of a sequence during a navigation session. For example, a particular experience may include (and the navigation application may display) turn-by-turn directions to a first location, and the user may stay at the first location for two hours. After two hours have elapsed, the navigation application may display turn-by-turn directions to a second location that is included as part of the particular experience, and the user may remain at the second location for one hour until the navigation application offers the user to potentially proceed to a third location. In this manner, the navigation application may display navigation directions to each POI in sequence, such that the user may proceed to each individual location as part of the larger, singular experience intended to appeal to the user's desires (e.g., a night out, visiting historic architecture, etc.).

Generally speaking, a user's computing device may generate experience recommendations including at least one POI for the user based on user data and the user's current location. The experience recommendations may include navigation instructions to each of the POIs included as part of the experience recommendation, and may be scheduled such that a user receives notifications (and directions) to travel from one POI to the next at appropriate time intervals. For example, a user may arrive in a new city, and the techniques of the present disclosure may automatically generate several experience recommendations that each include at least one POI for the user based on the user's data and their current location in the new city. The user's data may indicate that the user frequently visits seafood restaurants and jazz clubs in their home town, so the techniques of the present disclosure may generate an experience recommendation featuring a seafood restaurant and a jazz club in the new city for the user to experience. This experience recommendation may be automatically uploaded as an appointment to a calendar application of the user's computing device, and the user may choose to accept or deny the appointment. If the user accepts the appointment, then the calendar application may instruct and/or otherwise cause a navigation application to provide directions to the seafood restaurant from the user's current location at the time of the appointment. After a certain period of time and/or upon prompting from the user (e.g., after the meal), the navigation application may subsequently provide directions to the jazz club from the seafood restaurant. Once all planned POIs and/or all POIs the user intends to visit have been visited, the navigation application may also provide directions back to the user's accommodations (e.g., user's home, hotel, etc.). Accordingly, a user may be automatically and seamlessly guided through an experience-focused navigation session that is specifically tailored to the user's preferences and location.

Thus, aspects of the present disclosure provide a technical solution to the problem of disjointed, limited, and/or otherwise inappropriate navigation/POI recommendations by determining a semantic mapping corresponding to the user, generating proximity values for experience-focused navigation sessions, and automatically providing a suggested experience-focused navigation session to the user as an appointment on a calendar application of the user's computing device. For example, the user computing device may determine the semantic mapping based on user preferences and a location history of the user, that may be included as part of user data. Further, the user computing device may utilize a trained experience learning model to generate the proximity values based on the semantic mapping and the current location of the user, and may communicate with a remote navigation server to obtain a navigation route and the associated route data corresponding to the suggested experience-focused navigation session. In this manner, the user computing device may generate and provide a user with specifically tailored experiences that eliminates subsequent searches by the user and thereby reduces network traffic and correspondingly increases available bandwidth.

Further, the present techniques improve the overall user experience utilizing a navigation application, and more broadly, traveling around locations to POIs. The present techniques automatically determine experience-focused navigation sessions that are specifically tailored/curated to a user's preferences. This helps provide a more user friendly and relevant experience that increases user satisfaction with their travel/social plans, and decreases user confusion and frustration resulting from disjointed, limited (e.g., single location recommendation in response to user prompt), and/or otherwise inappropriate navigation/POI recommendations from conventional navigation applications. Furthermore, the experiences may be curated by a large body of connected users (e.g., navigation application users rating each POI), such that each experience is likely safe and enjoyable. The present techniques thus enable a safer, more user-specific, and a more enjoyable navigation session to POIs.

### Example Hardware and Software Components

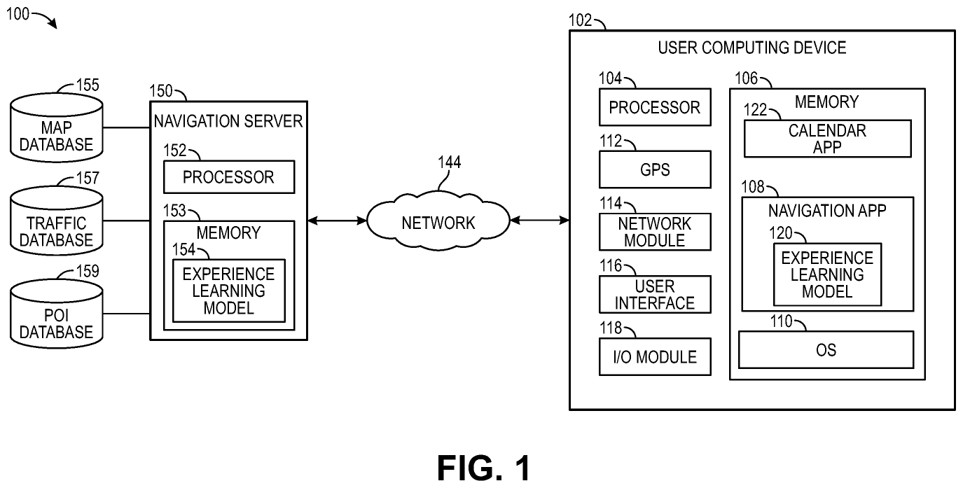

Referring first to FIG. 1, an example communication system 100 in which the techniques of this disclosure can be implemented includes a user computing device 102. The user computing device 102 may be a portable device such as a smart phone or a tablet computer, for example. The user computing device 102 may also be a laptop computer, a desktop computer, a personal digital assistant (PDA), a wearable device such as a smart watch or smart glasses, etc. In some embodiments, the user computing device 102 may be removably mounted in a vehicle, embedded into a vehicle, and/or may be capable of interacting with a head unit of a vehicle to provide navigation instructions.

The user computing device 102 may include one or more processor(s) 104 and a memory 106 storing machine-readable instructions executable on the processor(s) 104. The processor(s) 104 may include one or more general-purpose processors (e.g., CPUs), and/or special-purpose processing units (e.g., graphical processing units (GPUs)). The memory 106 can be, optionally, a non-transitory memory and can include one or several suitable memory modules, such as random access memory (RAM), read-only memory (ROM), flash memory, other types of persistent memory, etc. The memory 106 may store instructions for implementing a navigation application 108 that can provide navigation directions (e.g., by displaying directions or emitting audio instructions via the user computing device 102), display an interactive digital map, request and receive routing data to provide driving, walking, or other navigation directions, provide various geo-located content such as traffic, points-of-interest (POIs), and weather information, etc.

Further, the navigation application 108 may include an experience learning model 120 configured to implement and/or support the techniques of this disclosure for providing an experience-focused navigation session. Namely, the experience learning model 120 may generate proximity values that each correspond to an experience-focused navigation session for the user based on a semantic mapping and the user's current location. In some scenarios, the experience learning model 120 may be a machine learning model trained using training semantic data and training location data as input to output proximity values corresponding to a plurality of experiences, as described further herein. Further, the experience learning model may be a long short-term memory (LS™) model, and in certain aspects, may utilize calendar data of a user to generate the proximity values.

It is noted that although FIG. 1 illustrates the navigation application 108 as a standalone application, the functionality of the navigation application 108 also can be provided in the form of an online service accessible via a web browser executing on the user computing device 102, as a plug-in or extension for another software application executing on the user computing device 102, etc. The navigation application 108 generally can be provided in different versions for different operating systems. For example, the maker of the user computing device 102 can provide a Software Development Kit (SDK) including the navigation application 108 for the Android™ platform, another SDK for the iOS™ platform, etc.

The memory 106 may also store an operating system (OS) 110, which can be any type of suitable mobile or general-purpose operating system. The user computing device 102 may further include a global positioning system (GPS) 112 or another suitable positioning module, a network module 114, a user interface 116 for displaying map data and directions, and input/output (I/O) module 118. The network module 114 may include one or more communication interfaces such as hardware, software, and/or firmware of an interface for enabling communications via a cellular network, a Wi-Fi network, or any other suitable network such as a network 144, discussed below. The I/O module 118 may include I/O devices capable of receiving inputs from, and presenting outputs to, the ambient environment and/or a user. The I/O module 118 may include a touch screen, display, keyboard, mouse, buttons, keys, microphone, speaker, etc. In various implementations, the user computing device 102 can include fewer components than illustrated in FIG. 1 or, conversely, additional components.

The user computing device 102 may communicate with a navigation server 150 via a network 144. The network 144 may include one or more of an Ethernet-based network, a private network, a cellular network, a local area network (LAN), and/or a wide area network (WAN), such as the Internet. The navigation application 108 may receive map data, navigation directions, and other geo-located content from the navigation server 150. Further, the navigation application 108 may access map, navigation, and geo-located content that is stored locally at the user computing device 102, and may access the navigation server 150 periodically to update the local data or during navigation to access real-time information, such as real-time traffic data.

In certain aspects, the network 144 may include any communication link suitable for short-range communications and may conform to a communication protocol such as, for example, Bluetooth™ (e.g., BLE), Wi-Fi (e.g., Wi-Fi Direct), NFC, ultrasonic signals, etc. Additionally, or alternatively, the network 144 may be, for example, Wi-Fi, a cellular communication link (e.g., conforming to 3G, 4G, or 5G standards), etc. In some scenarios, the network 144 may also include a wired connection.

The navigation server 150 includes one or more processor(s) 152 and a memory 153 storing computer-readable instructions executable by the processor(s) 152. The memory 153 may store an experience learning model 154 that is similar to the experience learning model 120. The experience learning model 154 may support similar functionalities as the experience learning model 120 from the server-side and may facilitate generation of proximity values, as described herein. For example, the user computing device 102 may provide the navigation server 150 with user data and a current location of the user and request that the experience learning model 154 generate the proximity values.

Generally, the user computing device 102 may communicate with the navigation server 150 to obtain navigation instructions to each of the POIs included as part of the suggested experience. The navigation server 150 may generally optimize the route between the user's current location and each POI based on current traffic conditions, weather conditions, user preferences (e.g., avoid freeways, avoid narrow roads, avoid tolls, etc.), and/or any other suitable information. Each of these user preferences may be stored at the user computing device 102 and/or the navigation server 150. Regardless, when the navigation server 150 has generated at least one route from the user's current location to the POI, the server 150 may transmit the route(s) back to the user computing device 102 by the network 144 for display and/or further adjustments by the device 102 and/or the user.

Of course, route optimization may include any number of user preferences, contextual indications, and/or any other suitable metrics. For example, if a user intends to travel from point A to point B, a first route from point A to point B includes a toll road and several private roads, a second route includes only public roads, and the user has expressed a preference (e.g., via the navigation application 108) to avoid non-public roads, the route is optimized by generating the second route and corresponding navigation instructions for display to the user. The navigation server 150 may generate both routes, and may also send both routes to the user computing device 102 for consideration with the second route indicated as the primary route and the first route indicated as a secondary/alternate route. Further, the user computing device 102 and/or the user can select a particular navigation route received from the navigation server 150 depending on which available route has an earlier estimated time of arrival, has fewer maneuvers, has a shorter distance, requires less tolls, encounters less traffic, passes more points of interest, etc.

Together, the experience learning model 154 and the experience learning model 120 can operate as components of an experience-focused navigation system. Alternatively, the entire functionality of the experience learning model 154 can be implemented in the experience learning model 120.

In any event, the navigation server 150 may be communicatively coupled to various databases, such as a map database 155, a traffic database 157, and a point-of-interest (POI) database 159, from which the navigation server 150 can retrieve navigation-related data. The map database 155 may include map data such as map tiles, visual maps, road geometry data, road type data, speed limit data, etc. The traffic database 157 may store historical traffic information as well as real-time traffic information. The POI database 159 may store descriptions, locations, images, and other information regarding landmarks or points-of-interest. While FIG. 1 depicts databases 155, 157, and 159, the navigation server 150 may be communicatively coupled to additional, or conversely, fewer, databases. For example, the navigation server 150 may be communicatively coupled to a database storing weather data.

### Example Displays During Scenarios Involving Experience Focused Navigation Sessions

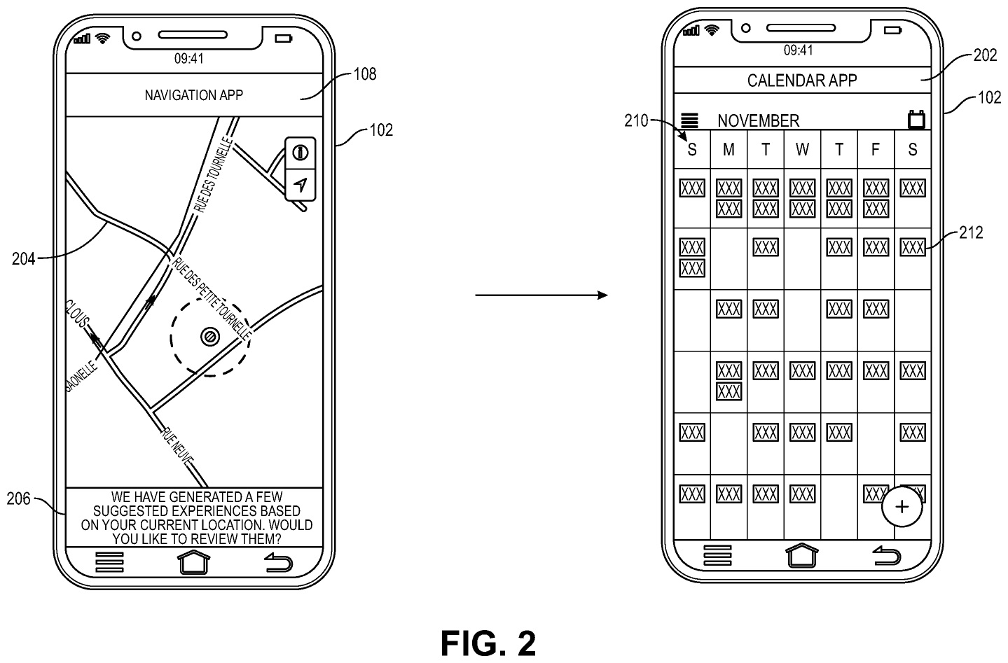

The techniques of this disclosure for providing an experience-focused navigation session are discussed below with reference to the displays illustrated in FIGS. 2-6. Throughout the description of FIGS. 2-6, actions described as being performed by the user computing device 102 may, in some implementations, be performed by the navigation server 150 or may be performed by the user computing device 102 and the navigation server 150 in parallel. For example, either the user computing device 102 and/or the navigation server 150 may utilize the experience learning model 120, 154 to generate proximity values corresponding to an experience-focused navigation session.

Referring to FIG. 2, the user computing device 102 may implement the navigation application 108 and display a graphical user interface (GUI) 204 of the navigation application 108. The navigation application 108 may also display a notification 206 somewhere within the GUI 204 notifying the user that the user computing device 102 may have generated a suggested experience for the user. For example, the user may be utilizing the navigation application 108 to identify where the user is currently located in an unfamiliar city, and the user computing device 102 may generate one or more suggested experiences for the user to examine. While the navigation application 108 is active, and the user is viewing the GUI 204, the user computing device 102 may then display the notification 206 to enable the user to interact with the notification and examine the suggested experiences. However, it should be understood that the user may be using any application stored on the user computing device 102 and/or not currently using the computing device 102 at all, and the device 102 may push the notification 206 to the user (e.g., notify through an audible tone, buzzing, etc.) to notify the user of the suggested experiences.

In any event, as illustrated in FIG. 2, the user may interact with the notification 206 (e.g., by tapping, clicking, swiping, etc.) and the user computing device 102 may transition between the navigation application 108 and the calendar application 202. The calendar application 202 may generally include appointments with corresponding times during which the user intends to perform, attend, and/or otherwise participate in a scheduled activity indicated by the respective appointment(s). The calendar application 202 may render the GUI 210, which displays the user's calendar and their appointments during the displayed period. The calendar application 202 may display all appointments currently scheduled for the user during, for example, a particular month (e.g., November, as illustrated in FIG. 2), and the calendar application 202 may include a first appointment 212 as part of the GUI 210 that corresponds to a suggested experience.

The user computing device 102 is configured to request user permission to access a user's calendar data and/or any other application or data therein. For example, when the user interacts with the notification 206, the user computing device 102 may prompt the user to approve accessing the user's calendar application/data. Responsive to receiving the user's approval, the user computing device 102 may proceed to access the user's calendar data, transition between the navigation application 108 and the calendar application 202, place appointments (e.g., first appointment 212) on the user's calendar, and/or any other suitable action or combinations thereof.

The suggested experience may include POIs, directions to each of the POIs, a duration spent performing the suggested experience, approximate times spent at each of the POIs, and/or any other suitable information or combinations thereof. Accordingly, the user computing device 102 may prompt the user with the notification 206, and may await a user interaction with the notification 206. Responsive to receiving a user interaction with the notification 206, the user computing device 102 may place the first appointment 212 on the user's calendar and transition from the navigation application 108 to the calendar application 202 to display the GUI 210. The first appointment 212 may be a tentative appointment, such that the user may have to explicitly accept the first appointment 212 for the calendar application 202 to provide subsequent reminders, alerts, and/or any other suitable functionality corresponding to the activities represented by the first appointment 212. However, in certain aspects, the calendar application 202 may place the first appointment 212 on the user's calendar without requiring explicit acceptance from the user. Regardless, should the user accept the first appointment 212, then the calendar application 202 may provide the user with subsequent reminders, alerts, updates, and/or other suitable information as the appointment approaches. Further, when the time indicated by the first appointment 212 arrives, the user computing device 102 may automatically activate the navigation application 108 to provide turn-by-turn directions to the POI(s) included as part of the suggested experience, as described herein.

Of course, if the user declines the first appointment 212, then the calendar application 202 may remove the first appointment 212 from the user's calendar. In this scenario, the user computing device 102 may cause the calendar application 202 to provide the user with another suggested experience through a second appointment (not shown) that may feature different POIs, different proposed date/time, different allotment of times for each POI, and/or any other suitable differences or combinations thereof. In certain aspects, the user computing device 102 may suggest multiple suggested experiences to the user initially upon receipt of the user's interaction with the notification 206, and may permit the user to peruse the selection of experiences to determine a preferred experience. Moreover, in some aspects, the user computing device 102 may automatically upload tentative and/or non-tentative appointment(s) representing experiences to the user's calendar application 202 without receiving a user interaction with the notification 206.

As an example, a user may arrive in an unfamiliar city for vacation on a Friday afternoon with the intention of exploring the unfamiliar city over the weekend. The user may open the user computing device 102, and may also open the navigation application 108 in order to know the user's current location within the unfamiliar city (e.g., at an airport). The user computing device 102 may receive the user's current location, and may compare the current location with a location history of the user to determine that the user is in a new location. The user computing device 102 may also access purchase and location histories of the user to identify user preferences related to activities/experiences. Moreover, the user computing device 102 may access the calendar application 202 and identify that the user has indicated their vacation to the new location by a vacation status extending from Friday afternoon to Sunday afternoon.

Using this location data, calendar data, and user preference data, the user computing device 102 (e.g., at least in part by the experience learning model 120) may determine a suggested experience for the user on Saturday afternoon. The suggested experience may include multiple POIs within the unfamiliar city, and may allot ample time at each POI to enable the user to fully experience each POI before moving to the next POI. When the allotted time for a particular POI has elapsed, the navigation application 108 may prompt the user to determine whether or not the user intends to travel to the next POI, and responsive to receiving an affirmative indication from the user, the navigation application 108 may automatically provide turn-by-turn directions from the current POI to the subsequent POI. After the user has finished visiting some/all POIs included as part of the suggested experience, the navigation application 108 may also provide turn-by-turn directions to take the user back to their accommodations (e.g., hotel, rented home, etc.).

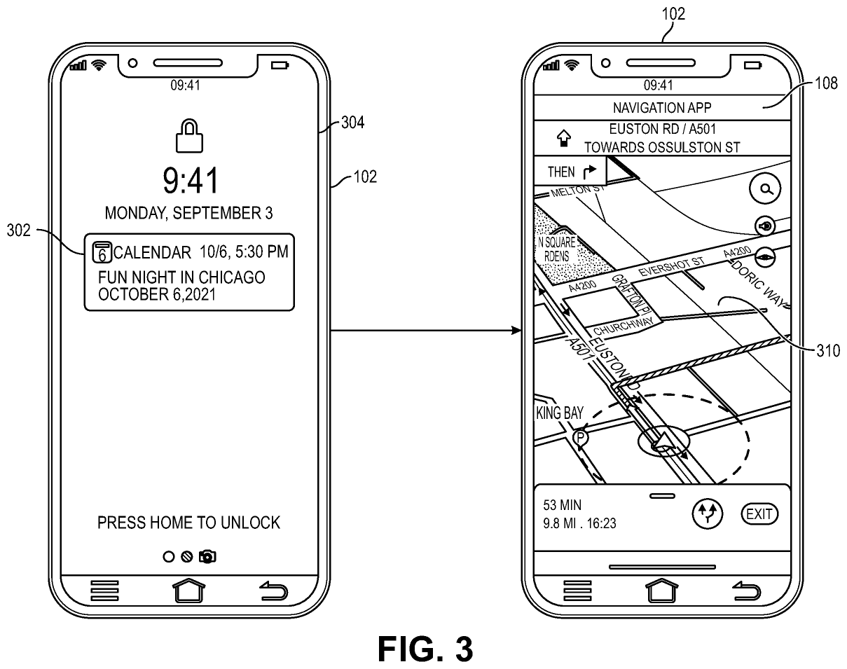

As mentioned, the user computing device 102 may provide the user with a notification 206 while the user is viewing the navigation application 108 and/or at any other suitable time, such as when the user is not utilizing the user computing device 102. FIG. 3 illustrates an example appointment notification 302 on a home screen GUI 304 that the user computing device 102 may generate regardless of whether or not the user is currently viewing and/or otherwise using the user computing device 102. Additionally, FIG. 3 illustrates a transition between the home screen GUI 304 and an experience-focused navigation session display 310 using the navigation application 108.

The user computing device 102 may generate the appointment notification 302 in response to determining that a suggested experience is about to commence. The user computing device 102 may push the appointment notification 302 to the home screen GUI 304 in order to remind the user about a previously accepted or tentative suggested experience, and to notify the user that the suggested experience is going to begin after a particular period of time (e.g., 5 minutes, 15 minutes, 1 hour, etc.). The appointment notification 302 may include a brief description of the suggested experience (e.g., “Fun night in Chicago”), and may further indicate when (date/time) the suggested experience is scheduled to begin (e.g., Oct. 6, 2021). However, it should be appreciated that the appointment notification 302 may include any suitable information, such as the POIs included in the suggested experience, time allotted for each POI, addresses for some/all POIs, directions to the POIs, and/or any other suitable information or combinations thereof.

Generally, the appointment notification 302 may act as both a reminder for the user and a selectable indication to begin the experience-focused navigation session. As such, when a user interacts with the appointment notification 302 and/or when the start time indicated in the notification 302 is reached, the user computing device 102 may transition from the home screen GUI 304 to the experience-focused navigation session display 310 rendered by the navigation application 108. If the home screen GUI 304 is locked, then the user computing device 102 may prompt the user to input access credentials in order to authorize the user and thereafter transition from the GUI 304 to the experience-focused navigation session display 310.

In any event, when the user computing device 102 transitions from the home screen GUI 304 to the experience-focused navigation session display 310, the navigation application 108 may cause the display 310 to provide the user with turn-by-turn navigation directions to a POI included as part of the experience-focused navigation session. More particularly, the user computing device 102 may initiate a first navigation session utilizing the navigation application 108 for providing a first set of navigation instructions from a starting location to a destination location (e.g., a first POI). The first set of navigation instructions may include turn-by-turn directions for reaching the first POI along a first route. During the first navigation session, the user computing device 102 may display, via the experience-focused navigation session display 310, a map depicting a location of the user computing device 102, a heading of the user computing device 102, an estimated time of arrival, an estimated distance to the first POI, an estimated time to the first POI, a current navigation direction, one or more upcoming navigation directions of the first set of navigation instructions, one or more user-selectable options for changing the display or adjusting the navigation directions, etc. The user computing device 102 may also emit audio instructions corresponding to the first set of navigation instructions.

When the user has completed the first set of navigation instructions, the user may arrive at the first POI, and the user computing device 102 may log the user's time of arrival. The user computing device 102 may track the amount of time the user spends at the first POI, and may suggest that the user proceed to a second POI after an amount of time allotted to the first POI has elapsed. For example, the first POI may be a restaurant, and the second POI may be a movie theater. The suggested experience may allot 2 hours for the first POI to enable the user to enjoy a meal at the restaurant, after which, the user computing device 102 may prompt the user with a notification to determine whether or not the user is prepared to travel to the movie theater. Responsive to receiving an affirmative response from the user, the user computing device 102 may initiate a second navigation session utilizing the navigation application 108 for providing a second set of navigation instructions from a starting location (e.g., the first POI) to a destination location (e.g., the second POI). The second navigation session may be similar to the first navigation session, and the second set of navigation instructions may provide the user with similar information and options to interact with the instructions as the first set of navigation instructions, with an exception being the turn-by-turn directions leading the user to the second POI along a second route. When the user arrives at the second POI, the user computing device 102 may log the user's arrival time, and the device 102 may perform similar analysis as previously described for determining when to provide a third navigation session to a third POI, a fourth navigation session to a fourth POI, etc.

Of course, if the user declines the notification to travel from the first POI to the second POI, the user computing device 102 may defer providing the second navigation session until the user indicates they are prepared to travel to the second POI. For example, the 2 hours allotted within the suggested experience may be insufficient to adequately enjoy a meal at the designated restaurant (e.g., the first POI). As a consequence, the user may not be prepared to travel to the second POI after the 2 hours following the user's arrival at the restaurant have elapsed. The user may decline the notification to initiate the second navigation session, continue enjoying their dining experience at the first POI, and may voluntarily initiate the second navigation session at any time after the meal has concluded.

In some aspects, the user computing device 102 may suggest alternative POIs in the event that a particular suggested POI as part of a suggested experience is not accepted by a user. Continuing the above example, the second POI included as part of the user's suggested experience may have included a particular movie showing at a particular time, such that the user would be able to travel from the first POI with enough time to make the showing of the particular movie. However, if the user takes substantially more time to enjoy a meal at the restaurant (the first POI) than was initially allotted by the user computing device 102, then by the time the user is ready to travel to the second POI, the movie may have already started and the user may be unable to enter the theater. Accordingly, the user computing device 102 may analyze the user's preference data, current location, and current time to determine an alternative suggested experience that would fit within the user's updated schedule. The user computing device 102 may inform the user that the movie has started, such that traveling to the originally intended second POI (the movie theater) may be unenjoyable, and the device 102 may additionally provide a notification of an alternative experience that the user has time for and may have interest in based on their preferences indicated in the user data.

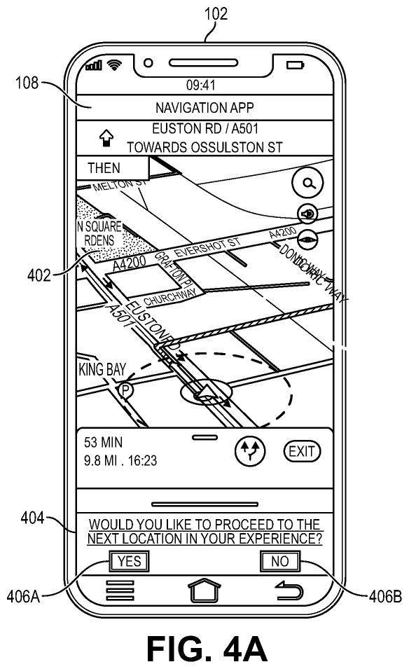

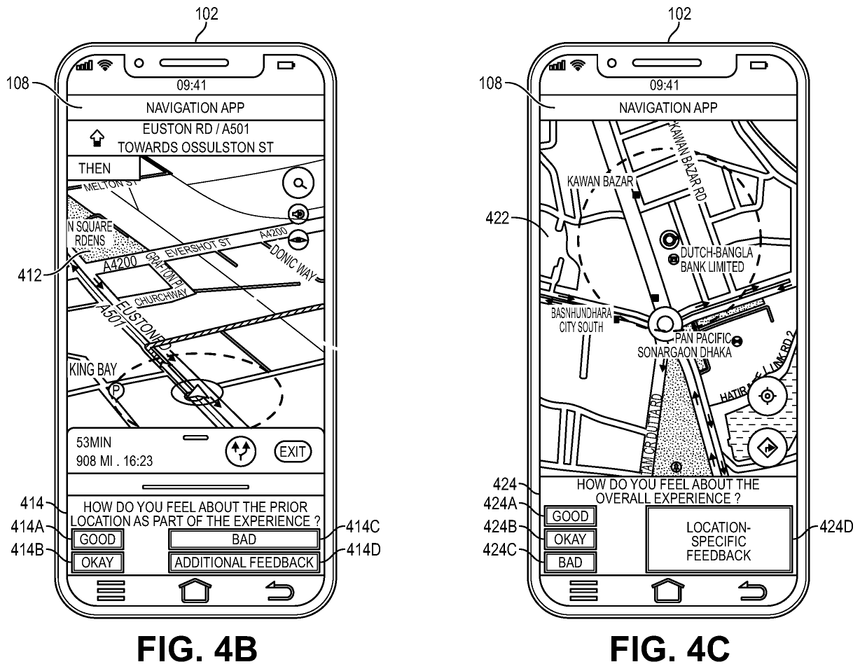

To provide a better understanding of the updates and notifications provided by the user computing device 102, FIGS. 4A-4C illustrate example navigation application displays requesting various user feedback to enhance and/or otherwise adjust the experience-focused navigation sessions. As previously mentioned, the suggested experience includes turn-by-turn directions to each POI included on the schedule of the suggested experience, and the user computing device 102 may request user input when determining whether or not to activate the navigation application 108 and provide the directions to the user. Further, when the user computing device 102 determines that a user may wish to proceed from a first POI to a second POI, the device 102 may prompt the user to provide input indicating as such. Accordingly, as illustrated in FIG. 4A, the user computing device 102 may render the GUI 402 via the navigation application 108 in order to provide the prompt 404 to the user. Additionally, or alternatively, the user computing device 102 may determine that the allotted time for the first POI has elapsed, and may provide the prompt 404 to the user through a locked home screen (e.g., home screen GUI 302).

Regardless, when the user receives the prompt 404, the user may interact with the prompt 404 by pressing, clicking, tapping, swiping, etc. one of the interactive buttons 406a, 406b. If the user selects the yes interactive button 406a, then the user computing device 102 may instruct the navigation application 108 to generate and display turn-by-turn navigation directions from the first POI to the second POI on the GUI 402. If the user selects the no interactive button 406b, then the user computing device 102 may determine an alternative experience and/or POI suggestion to replace the second POI and/or remainder of the suggested experience for the user to consider in the event that the user is uninterested in proceeding with the suggested experience.

As an example, the user may be visiting a museum, and at the end of the time allotted for the museum in the schedule of the suggested experience, the user computing device 102 may prompt the user to potentially proceed to the next POI, which may be a local bistro for lunch. The user may decide that they are uninterested in the local bistro, and instead want to have a quick coffee at a nearby café. The user may select the no interactive button 406b and proceed to the nearby café. The user computing device 102 may analyze the user's current location to determine that the user is currently at the nearby café, and that the user likely no longer requires an experience related to food/drink. As a result, the user computing device 102 may suggest experiences directed toward alternate activities that may interest the user after dining at the café, such as a walking tour of a city historic district or boutique shopping locations.

When a user has completed a portion of the suggested experience, the user computing device 102 may request feedback from the user to evaluate the interest/satisfaction level with the particular POI and/or with the overall suggested experience. Using this feedback, the user computing device 102 may enhance the overall experience by determining whether or not certain POIs should be included in particular experiences, and/or which experiences should be suggested to particular users, as discussed herein. For example, as illustrated in FIG. 4B, the navigation application 108 may instruct the user computing device 102 to display the GUI 412, featuring directions to a second, third, and/or otherwise subsequent POI after at least a first POI included as part of the suggested experience.

The user computing device 102 may cause the navigation application 108 and/or otherwise independently render the prompt 414 that is intended to gather user feedback regarding the prior POI the user just experienced. The prompt 414 includes four interactive buttons 414a, 414b, 414c, 414d, that allow the user to provide various forms of feedback regarding the prior POI. In particular, the good interactive button 414a may enable a user to provide a positive review/feedback regarding the prior POI, the okay interactive button 414b may enable a user to provide an average review/feedback regarding the prior POI, the bad interactive button 414c may enable a user to provide a negative review/feedback regarding the prior POI, and the additional feedback interactive button 414d may enable a user to provide additional feedback regarding the prior POI.

For example, the user may visit a first POI as part of a suggested experience, and may not enjoy the experience. When the user leaves the first POI, the user computing device 102 may provide the prompt 414 to the user to enable the user to provide feedback regarding the first POI, and the user may select the bad interactive button 414c. The user computing device 102 may receive this input and utilize it to further analyze the inclusion of the first POI as part of the suggested experience and/or more generally as a recommended POI for any/all experiences. Additionally, the user computing device 102 may provide the user with a fillable text box in which the user may provide comments related to their selection of the bad interactive button 414c. Any comments provided by the user may be received by the user computing device 102 and used, for example, to display to future users of the suggested experiences to provide the future users with additional information related to the first POI. The user computing device 102 may also forward any received comments (anonymized or otherwise) to the first POI (e.g., a computing terminal associated with the first POI), to enable employees/managers/owners of the first POI to read the comments, and potentially respond, adjust their practices accordingly, and/or otherwise interpret the information contained therein.

As another example, the user may visit a first POI and a second POI as part of a suggested experience, and the user may determine that the second POI should be suggested as the first POI and the first POI should be the second POI. The user may have enjoyed the second POI regardless, and so the user may select both the good interactive button 414a and the additional feedback interactive button 414d to leave comments indicating as much. The user's selection of the good interactive button 414a may indicate that the second POI provided a high quality experience for the user, and the user may provide comments after selection of the additional feedback interactive button 414d explaining that the suggested experience would be improved overall if the second POI and the first POI were scheduled in reverse order. As such, the feedback provided by the user after selection of the additional feedback interactive button 414d may not necessarily be held against the second POI (e.g., influencing a rating of the second POI as part of the overall experience catalogue), but may be used by the user computing device 102 to determine a more optimal arrangement of the suggested experience including the first POI and the second POI.

To that end, a user may wish to provide feedback regarding the overall suggested experience, in addition to or as opposed to POI-specific feedback. The user may provide such comments during the suggested experience, for example, using the additional feedback interactive button 414d. Additionally, or alternatively, the user computing device 102 may provide the user with an opportunity to provide broad feedback related to the overall suggested experience after visiting each POI included on the schedule of the suggested experience.

More specifically, as illustrated in FIG. 4C, the navigation application 108 may instruct the user computing device 102 to display the GUI 422, featuring a user's current location after some/all of the POIs included as part of the suggested experience. The user computing device 102 may cause the navigation application 108 and/or otherwise independently render the prompt 424 that is intended to gather user feedback regarding the suggested experience the user just experienced. The prompt 424 includes four interactive buttons 424a, 424b, 424c, 424d, that allow the user to provide various forms of feedback regarding the suggested experience. In particular, the good interactive button 424a may enable a user to provide a positive review/feedback regarding the suggested experience, the okay interactive button 424b may enable a user to provide an average review/feedback regarding the suggested experience, the bad interactive button 424c may enable a user to provide a negative review/feedback regarding the suggested experience, and the location-specific feedback interactive button 424d may enable a user to provide location-specific and/or otherwise additional feedback regarding the suggested experience.

As an example, a user may participate in a suggested experience, and after the user has completed the scheduled activities as part of the suggested experience, the user computing device 102 may provide the prompt 424 to the user requesting feedback on the user's overall experience. The user may feel that the suggested experience was satisfactory, but that there was not quite enough time allocated for each POI to facilitate a fully enjoyable experience at each POI. The user may thus select the okay interactive button 424b. Selection of the okay interactive button 424b may enable the user to provide additional comments regarding their impressions of the suggested experience, and may enable the user computing device 102 to upload these comments to a central server (e.g., navigation server 150) for storage. The selection of the okay interactive button 424b along with the comments may be utilized by the central server to update a rating associated with the suggested experience and to provide subsequent users of the suggested experience with insight related to the suggested experience. Thereafter, a subsequent user may receive the suggested experience on their computing device, may read the comments from the user related to the insufficient time allocation, and the subsequent user may decide to eliminate a POI on the schedule of the suggested experience to potentially achieve a better experience at the remaining POIs.

In certain instances, a user may not receive suggested experiences because they are in their home location (e.g., their city/town/village of residence) and/or they may have the service deactivated on their computing device. However, in these instances, the user may travel to a POI and desire to extend their experience by traveling to a subsequent POI. For example, a user may go out for lunch in their home city on a weekend, and may desire to travel to a subsequent location to participate in an engaging activity. To help users in their search for such activities, POIs may include scannable indicia that may activate a suggested experience for a user that includes subsequent activities a user may in which a user may wish to engage after visiting the POI.

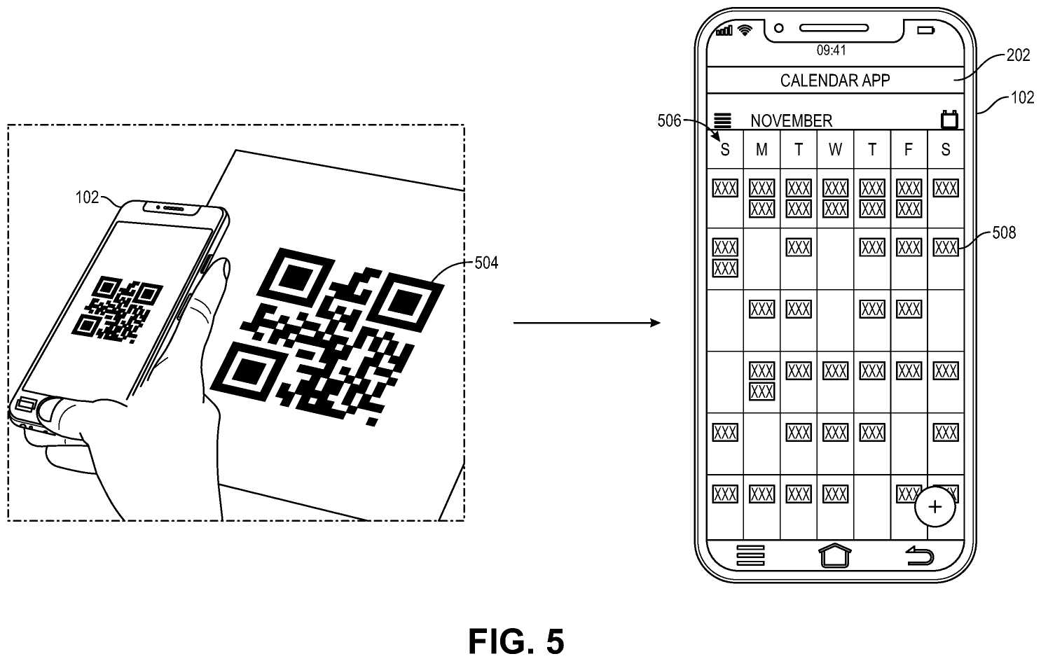

Continuing the prior example, and as illustrated in FIG. 5, the user out to lunch in their home city may locate the scannable indicia 504 (e.g., a quick response (QR) code) in the restaurant, and may capture an image of the scannable indicia 504 with their user computing device 102. The user computing device 102 may decode the payload included in the scannable indicia 504, which may instruct the device 102 to generate an appointment 508 on the user's calendar 506 in the calendar application 202. The appointment 508 may be and/or otherwise include a suggested experience associated with the restaurant in which the user is located and scanned the scannable indicia 504. For example, the appointment 508 may be scheduled to begin shortly after the user scans the indicia 504, and may include a scheduled stop to an art gallery located a few blocks away from the restaurant. When the user accepts the appointment 508 and the scheduled start time arrives, the calendar application 202 may instruct the navigation application 108 to begin a navigation session with turn-by-turn directions to the art gallery.

As part of the association of the restaurant and the art gallery through the suggested experience in the prior example, the user may receive benefits from traveling between the restaurant and the art gallery as a result of scanning the scannable indicia 504. For example, in some instances, the art gallery and the restaurant may have a reciprocal agreement in place to offer discounted prices to patrons to their establishments when participating in the experience provided as a result of scanning the scannable indicia 504. Namely, the user who has lunch in the restaurant, scans the scannable indicia 504, and thereafter proceeds to the art gallery and is able to produce a corresponding code or indicia indicating the user's scanning of the indicia 504 at the restaurant may receive a discounted price of admission to the art gallery.

In this manner, the POIs involved in these experiences may receive increased business from users directed to their establishments from associated establishments, and users may receive attractive discounts and/or other offers to visit these POIs in addition to participating in a generally engaging, enjoyable experience. Of course, in certain circumstances, the POIs included in suggested experiences may be landmarks, historic buildings, parks, and/or other locations that do not directly include a business. In these circumstances, the benefits associated with traveling between a landmark POI to a business POI may extend only in one direction (e.g., discounts traveling from the landmark POI to the business POI).

In any event, when a user scans the scannable indicia 504 and an appointment 508 is placed on the user's calendar, the user may choose to accept or decline the appointment 508. If the user declines the appointment 508, then the user computing device 102 may provide alternative suggested experiences, as previously mentioned, and/or may simply remove the appointment 508 from the user's calendar. However, if the user accepts the appointment 508, the navigation application 108 may display turn-by-turn directions to the next POI at the scheduled start time of the experience. Additionally, or alternatively, the user scanning the scannable indicia 504 may cause the navigation application 108 to automatically open and provide turn-by-turn directions to the next POI.

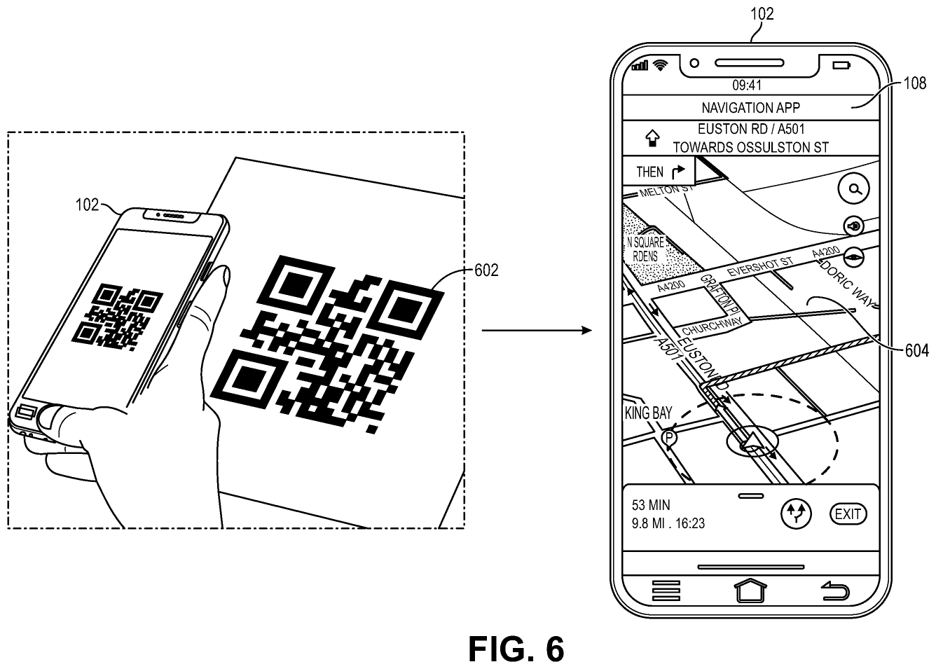

For example, as illustrated in FIG. 6, the user may scan/image the scannable indicia 602 with the user computing device 102. As a result, the payload of the scannable indicia 602 may cause the navigation application 108 to open and automatically display the GUI 604 featuring turn-by-turn directions to the subsequent POI. As the user is traveling to the subsequent POI, the user computing device 102 may display feedback options for the user to review the prior POI, similar to the prompt 414 of FIG. 4B, despite the user not traveling to the prior POI as part of a pre-planned, suggested experience. Moreover, as the user proceeds to each POI included as part of the experience from the scannable indicia 602, the device 102 may prompt the user for feedback related to each POI, and the device 102 may also prompt the user for feedback corresponding to the overall experience, similar to the prompt 424 of FIG. 4C. Using this feedback, the individual POIs can evaluate the efficacy of the experience, and whether or not to adjust it in any way (e.g., partnering with another establishment for a more lucrative experience).

Additionally, or alternatively, the user computing device 102 may detect whether another device in proximity to the user computing device 102 is participating in an experience, and whether or not to request the experience from the other device. For example, a friend of the user may have selected and be actively participating in a suggested experience while the two are out together. The user may wish to view the suggested experience on their own device, and may request that the friend's device share the suggested experience with the user's device. The friend may accept the user's request, and the friend's device may transmit a signal to the user's device that includes the suggested experience. The user may then tap, click, swipe, etc. on a notification to activate the suggested experience in the navigation application, and the user's device may then automatically display the turn-by-turn directions, a list of the POIs included in the schedule, and/or any other suitable information related to the suggested experience.

In some scenarios, the user computing device 102 may only attempt to discover experiences from other devices if an interoperability feature of the navigation application 108 is triggered. Generally, the interoperability feature may be manually triggered by the user, or may be triggered as a default option. Regardless, the user computing device 102 may detect whether another device in proximity to the first device is implementing an experience-focused navigation session in a variety of ways. In some implementations, the user computing device 102 can detect that a nearby computing device is implementing an experience-focused navigation session by receiving an indication in a broadcast, over a communication link (e.g., network 144), from the nearby computing device. For example, the nearby computing device may broadcast that the nearby computing device is currently implementing an experience-focused navigation session. The user computing device 102 may broadcast the request to join the experience-focused navigation session to the nearby computing device, such that the nearby computing device may be capable of discovering the user computing device 102 over the communication link.

As a more particular example, the nearby computing device can broadcast that the user is currently engaging in the experience-focused navigation session (e.g., a discoverable message) in accordance with a protocol such as Bluetooth™. The nearby computing device may encode the message with an identity of the nearby computing device and the message may include an indication that the nearby computing device may share the experience-focused navigation session with the user computing device 102. The user computing device 102 can monitor for discoverable devices on frequencies associated with the protocol. After detecting the nearby computing device, the user computing device 102 may provide an identity of the user computing device 102 to the nearby computing device along with the request to obtain the experience-focused navigation session. In response, the nearby computing device may return a signal including access to the experience-focused navigation session, thereby enabling the user computing device 102 to access the experience-focused navigation session.

### Example Logic for Providing an Experience Focused Navigation Session

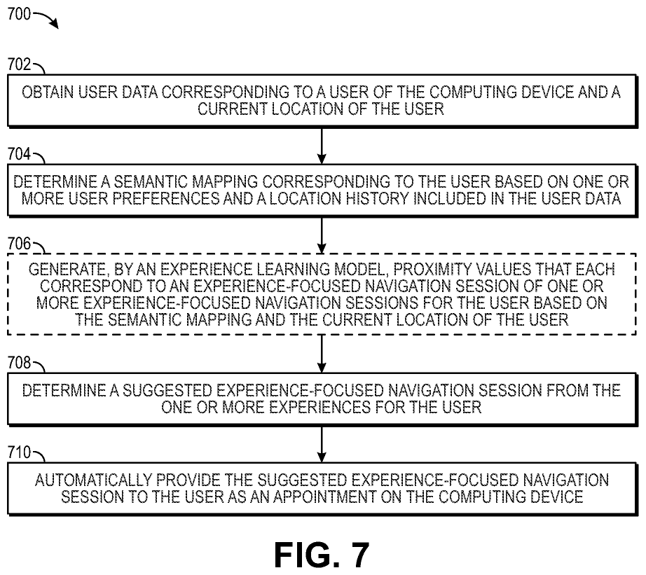

FIG. 7 is a flow diagram illustrating an example method for providing an experience-focused navigation session, in accordance with the techniques of this disclosure. It is to be understood that, for ease of discussion only, the “user computing device” discussed herein in reference to FIG. 7 may correspond to the user computing device 102.

Turning to FIG. 7, a method 700 can be implemented by a user computing device (e.g., the user computing device 102). The method 700 can be implemented in a set of instructions stored on a computer-readable memory and executable at one or more processors of the user computing device (e.g., the processor(s) 104).

At block 702, the one or more processors of a user computing device may obtain user data corresponding to a user of the computing device and a current location of the user. In certain aspects, the user data may include timing data comprising at least one of (i) time of year data, (ii) day of the week data, or (iii) time of day data. For example, the user data may indicate that a user is in a particular location at noon on a Friday in the middle of Fall. The current location of the user may include a city or county, as well as a particular address or an approximate location, such as near the Louvre in Paris, France.

At block 704, the one or more processors of the user computing device may determine a semantic mapping corresponding to the user based on one or more user preferences and a location history included in the user data. In certain aspects, the one or more user preferences correspond to a purchase history of a user and the location history includes one or more locations visited by the user. For example, the one or more user preferences may indicate that a user consistently shops at antique stores, and that the user also consistently travels to popular tourist destinations in various locations. As a result, the user computing device may determine that the semantic mapping of the user should correspond to antiques and popular tourist attractions when utilizing the semantic mapping to determine a suggested experience-focused navigation session for the user.

More generally, generating the semantic mapping may include the user computing device and/or other suitable processing device distilling/reducing information included as part of the one or more user preferences and the location history of the user into a set of concepts that broadly describe the interests of a user. As another example, the one or more user preferences may indicate that the user frequently buys artwork and pizza, and that the user has visited local blues bars, art museums, and Italian restaurants in various locations that are different from the user's home city/town. The one or more processors of the user computing device may use this general information to generate a semantic mapping that heavily features art, food, and music. For each of these categories, the semantic mapping may further include sub-categories referencing a particular type of artwork enjoyed by the user (e.g., watercolors, oils, impressionist, abstract, Renaissance era, etc.), a particular type of food enjoyed by the user (e.g., pizza, Italian, etc.), and/or a particular type of music enjoyed by the user (e.g., blues, pop, R&B, soul, classical, etc.), to the extent that such information is included as part of the one or more user preferences and the location history of the user.

As such, using the semantic mapping, the user computing device (e.g., the experience learning model 120) may determine how likely a particular experience may align with a user's interests based on the degree of similarity the particular experience has with the user's semantic mapping. Referencing the prior example, a particular experience may include tags indicating that the particular experience includes a stop at an Italian restaurant with very high reviews of their pizza followed by a trip to a local movie theater for a film regarding a blues musician. The user computing device may analyze the particular experience to determine that the user may enjoy this experience because the user's semantic mapping includes references to food (specifically Italian and pizza) and to music (specifically blues). If the movie playing at the movie theater was instead focused on a pop musician, the user computing device may still interpret the experience as one the user may be interested in performing because the movie may include tags relating it to music, which is also included on the user's semantic mapping (at a broader level than blues music). However, in this case, the movie regarding the pop musician may receive a lower correlation value (confidence score, etc.) than the movie regarding the blues musician because the user's semantic mapping more closely aligns with the blues musician movie.

At optional block 706, the user computing device may utilize an experience learning model to generate proximity values that each correspond to an experience-focused navigation session of one or more experience-focused navigation sessions for the user based on the semantic mapping and the current location of the user. The experience learning model may be a machine learning (ML) model, a rules-based model, and/or any other suitable type of model or combinations thereof. The proximity values may generally correspond to how closely particular experience-focused navigation sessions correlate with the semantic mapping and current location of the user.

More specifically, the experience learning model may utilize various contextual parameters to correlate each experience-focused navigation session to the semantic mapping and current location of the user. For example, the experience learning model may analyze contextual parameters from an experience-focused navigation session indicating that (1) the experience is located in Paris, (2) the experience is 4 hours long, and that (3) the experience includes live music and historic architecture touring. Further, the experience learning model may analyze corresponding contextual parameters from the semantic mapping and current location of the user indicating that (1) the user is located in Paris, (2) the user typically stays out for less than 3 hours at a time before returning home, and that (3) the user rarely listens to live music and never tours historic architecture. The contextual parameters may also indicate that (4) the weather forecast corresponding to areas covered by the experience are predicted to include rain during the scheduled times at the POIs, and that (5) multiple vehicles currently traveling along a portion of the navigation route between the two POIs are reporting heavy traffic.

In the prior example, the model may apply weighting factors to the contextual parameters in order to potentially achieve a more accurate representation of the implications of the contextual parameters. Namely, the model may apply larger weighting factors to contextual parameters (1), (2), and (3), than parameters (4) and (5) because parameters (1), (2), and (3) have analogous parameters in the semantic mapping and the current location of the user. Moreover, if the events taking place at the POIs are inside and therefore not impacted by rain, then the model may apply a much smaller weighting factor to parameter (4) to decrease its impact on the resulting proximity value corresponding to the experience-focused navigation session. The model may associate a general lack of interest in extended experiences (e.g., contextual parameters (2)) along with a general lack of interest in the planned activities (e.g., contextual parameters (3)) as an increased likelihood of the user not accepting the experience-focused navigation session. Further, the model may associate an extended period of high-traffic travel (e.g., contextual parameter (5)) in order to reach the next POI with an even higher chance of the user not accepting the experience-focused navigation session.

Overall, the model may apply a weighting factor to all or some of contextual parameters (1)-(5) to decrease/increase their impact on the resulting proximity value for the experience-focused navigation session. The user computing device may then evaluate all generated proximity values for the experience-focused navigation sessions to determine the suggested experience-focused navigation session. Namely, the user computing device may determine that the suggested experience-focused navigation session should include activities in Paris that involve activities of interest to the user (e.g., not live music or touring historical architecture) that do not last longer than 3 hours.

In some aspects, the experience learning model is a machine learning model trained using training semantic data and training location data as input to output proximity values corresponding to a plurality of experiences. For example, the experience learning model may be a long short-term memory (LS™) model. In these aspects, the first computing device may include a machine learning engine to train the experience learning model, and/or the user computing device may include a pre-trained experience learning model. The machine learning engine may train the experience learning model using various machine learning techniques such as a regression analysis (e.g., a logistic regression, linear regression, or polynomial regression), k-nearest neighbors, decisions trees, random forests, boosting (e.g., extreme gradient boosting), neural networks, support vector machines, deep learning, reinforcement learning, Bayesian networks, etc. The experience learning model may utilize any standard techniques such as a LS™ model, and/or any other suitable machine learning models such as a linear regression model, a logistic regression model, a decision tree, a neural network, a hyperplane, and/or any combinations thereof.

More specifically, to train the experience learning model, the machine learning engine may receive training data including a plurality of sets of training semantic data and training location data corresponding to a plurality of users, and a plurality of proximity values corresponding to the plurality of sets of training semantic data and training location data. While the training data discussed herein includes a plurality of sets of training semantic data and training location data corresponding to a plurality of users, and a plurality of proximity values, this is merely an example for ease of illustration only. The training data may include any number of sets of training semantic data and training location data corresponding to a plurality of users (e.g., additional users utilizing aspects of the present disclosure), and proximity values.

Moreover, while generating the proximity values has been described within the context of a machine learning environment, it is to be appreciated that generating the proximity values may occur without a machine learning process. For example, the user computing device may determine the proximity values based on a relational database, weighting logic, heuristic rules, grammar, and/or any other suitable algorithmic architecture.

In certain aspects, the user computing device may receive, at the one or more processors, user feedback corresponding to completion of at least a portion of the suggested experience-focused navigation session. Further, the user computing device may train, by the one or more processors utilizing, for example, the machine learning engine, the experience learning model with the user feedback to provide better, more accurate proximity values.

In some aspects, the user data corresponding to the user includes calendar data of the user, and the experience learning model may generate the proximity values based on the semantic mapping, the current location of the user, and the calendar data of the user. In these aspects, the user computing device may automatically provide, by the one or more processors, the suggested experience-focused navigation session to the user as the appointment on a calendar application of the computing device.

At block 708, the user computing device may determine a suggested experience-focused navigation session for the user based on the semantic mapping and the current location of the user. The suggested experience-focused navigation session may include an ordered list of one or more suggested points of interest, enabling the user to determine what POIs are included, and whether or not the user is interested in visiting/participating in the activities represented therein. For example, the user computing device may analyze the proximity values generated by the experience learning model, and may determine that the experience-focused navigation session with the highest corresponding proximity value should be the suggested experience-focused navigation session.

At block 710, the user computing device may automatically provide, by the one or more processors, the suggested experience-focused navigation session to the user as an appointment on the computing device. In certain aspects, the suggested experience-focused navigation session includes (i) the ordered list of one or more suggested points of interest and (ii) sequential navigation directions to each suggested point of interest on the ordered list. Further, the suggested experience-focused navigation session may include a start time, and the user computing device may receive, at the one or more processors by a user interface of the computing device, an acceptance indication from the user to confirm acceptance of the suggested experience-focused navigation session. Upon reaching the start time, the user computing device may automatically provide, by the one or more processors, the sequential navigation directions on a navigation application of the computing device to guide the user to each of the one or more suggested points of interest on the ordered list. Additionally, or alternatively, the user computing device may receive a quick read (QR) code scanned by the user at a first location. Responsive to receiving the QR code, the user computing device may determine the suggested experience-focused navigation session, and the ordered list may include (i) at least a second location and (ii) the sequential navigation directions from the first location to the second location.

In some aspects, the user computing device may determine, by the one or more processors, one or more indications of satisfaction corresponding to the user not completing a portion of the suggested experience-focused navigation session. Generally, the one or more indications of satisfaction may include (i) not visiting one or more of the one or more suggested points of interest, (ii) visiting an alternative point of interest instead of one of the one or more suggested points of interest, and/or (iii) receiving a denial indication from the user of the suggested experience-focused navigation session. The user computing device may then combine, by the one or more processors, each of the one or more indications of satisfaction into a satisfaction metric value, and assign the satisfaction metric value to the suggested experience-focused navigation session.

In certain aspects, the user computing device may tag, by the one or more processors, the suggested experience-focused navigation session with one or more tags indicating a type of experience. In these aspects, the user computing device may upload, by the one or more processors, the suggested experience-focused navigation session to a social media platform with the one or more tags to share the suggested experience-focused navigation session with other users. For example, the user computing device may assign tags indicating “music” and “inexpensive” to a particular experience-focused navigation session, and may upload the particular experience-focused navigation session to a social media platform (e.g., Facebook, Twitter, Instagram, etc.) in an attempt to share the particular experience-focused navigation session with users of the social media platform who may be interested in such an experience.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 700, 800 may include one or more function blocks, modules, individual functions or routines in the form of tangible computer-executable instructions that are stored in a computer-readable storage medium, optionally a non-transitory computer-readable storage medium, and executed using a processor of a computing device (e.g., a server device, a personal computer, a smart phone, a tablet computer, a smart watch, a mobile computing device, or other client computing device, as described herein). The methods 700, 800 may be included as part of any backend server (e.g., a map data server, a navigation server, or any other type of server computing device, as described herein), client computing device modules of the example environment, for example, or as part of a module that is external to such an environment. Though the figures may be described with reference to the other figures for ease of explanation, the methods 700, 800 can be utilized with other objects and user interfaces. Furthermore, although the explanation above describes steps of the methods 700, 800 being performed by specific devices (such as a first computing device or a second computing device), this is done for illustration purposes only. The blocks of the methods 700, 800 may be performed by one or more devices or other parts of the environment.

### Aspects of the Present Disclosure

1. A method in a computing device for providing an experience-focused navigation session, the method comprising: obtaining, at one or more processors of the computing device, user data corresponding to a user of the computing device and a current location of the user; determining, by the one or more processors, a semantic mapping corresponding to the user based on one or more user preferences and a location history included in the user data; determining, by the one or more processors, a suggested experience-focused navigation session for the user based on the semantic mapping and the current location of the user, wherein the suggested experience-focused navigation session includes an ordered list of one or more suggested points of interest; and automatically providing, by the one or more processors, the suggested experience-focused navigation session to the user as an appointment on the computing device.
2. The method of aspect 1, further comprising: generating, by an experience learning model, proximity values that each correspond to an experience-focused navigation session of one or more experience-focused navigation sessions for the user based on the semantic mapping and the current location of the user.
3. The method of aspect 2, wherein the user data corresponding to the user includes calendar data of the user, and the method further comprises: generating, by the experience learning model, the proximity values based on the semantic mapping, the current location of the user, and the calendar data of the user; and automatically providing, by the one or more processors, the suggested experience-focused navigation session to the user as the appointment on a calendar application of the computing device.
4. The method of any of aspects 2-3, wherein the experience learning model is a machine learning model trained using training semantic data and training location data as input to output proximity values corresponding to a plurality of experiences.
5. The method of aspect 4, wherein the experience learning model is a long short-term memory (LS™) model.
6. The method of any of aspects 2-5, further comprising: receiving, at the one or more processors, user feedback corresponding to completion of at least a portion of the suggested experience-focused navigation session; and training, by the one or more processors, the experience learning model with the user feedback.
7. The method of any of aspects 1-6, wherein the suggested experience-focused navigation session includes (i) the ordered list of one or more suggested points of interest and (ii) sequential navigation directions to each suggested point of interest on the ordered list.
8. The method of aspect 7, wherein the suggested experience-focused navigation session includes a start time, and the method further comprises: receiving, at the one or more processors by a user interface of the computing device, an acceptance indication from the user to confirm acceptance of the suggested experience-focused navigation session; and upon reaching the start time, automatically providing, by the one or more processors, the sequential navigation directions on a navigation application of the computing device to guide the user to each of the one or more suggested points of interest on the ordered list.
9. The method of any of aspects 7-8, further comprising: receiving, at the one or more processors, a quick read (QR) code scanned by the user at a first location; and responsive to receiving the QR code, determining the suggested experience-focused navigation session, wherein the ordered list includes (i) at least a second location and (ii) the sequential navigation directions from the first location to the second location.
10. The method of any of aspects 1-9, further comprising: determining, by the one or more processors, one or more indications of satisfaction corresponding to the user not completing a portion of the suggested experience-focused navigation session, wherein the one or more indications of satisfaction includes (i) not visiting one or more of the one or more suggested points of interest, (ii) visiting an alternative point of interest instead of one of the one or more suggested points of interest, or (iii) receiving a denial indication from the user of the suggested experience-focused navigation session.
11. The method of aspect 10, further comprising: combining, by the one or more processors, each of the one or more indications of satisfaction into a satisfaction metric value; and assigning, by the one or more processors, the satisfaction metric value to the suggested experience-focused navigation session.
12. The method of any of aspects 1-11, wherein the one or more user preferences correspond to a purchase history of a user and the location history includes one or more locations visited by the user.
13. The method of any of aspects 1-12, wherein the user data includes timing data comprising at least one of (i) time of year data, (ii) day of the week data, or (iii) time of day data.
14. The method of any of aspects 1-13, further comprising: tagging, by the one or more processors, the suggested experience-focused navigation session with one or more tags indicating a type of experience; and uploading, by the one or more processors, the suggested experience-focused navigation session to a social media platform with the one or more tags to share the suggested experience-focused navigation session with other users.
15. A computing device for providing an experience-focused navigation session, the computing device comprising: one or more processors; and a non-transitory computer-readable memory coupled to the one or more processors and storing instructions thereon that, when executed by the one or more processors, cause the computing device to: obtain user data corresponding to a user of the computing device and a current location of the user, determine a semantic mapping corresponding to the user based on one or more user preferences and a location history included in the user data, determine a suggested experience-focused navigation session for the user based on the semantic mapping and the current location of the user, wherein the suggested experience-focused navigation session includes an ordered list of one or more suggested points of interest, and automatically provide the suggested experience-focused navigation session to the user as a notification on the computing device.
16. The computing device of aspect 15, wherein the user data corresponding to the user includes calendar data of the user, and the instructions, when executed by the one or more processors, further cause the computing device to: generate, by an experience learning model, proximity values that each correspond to an experience-focused navigation session of one or more experience-focused navigation sessions for the user based on the semantic mapping and the current location of the user, wherein the proximity values are based on the semantic mapping, the current location of the user, and the calendar data of the user, and automatically provide, by the one or more processors, the suggested experience-focused navigation session to the user as the appointment on a calendar application of the computing device.
17. The computing device of any of aspects 15-16, wherein the suggested experience-focused navigation session includes (i) the ordered list of one or more suggested points of interest, (ii) sequential navigation directions to each suggested point of interest on the ordered list, and (iii) a start time, and the instructions, when executed by the one or more processors, further cause the computing device to: receive, by a user interface, an acceptance indication from the user to confirm acceptance of the suggested experience-focused navigation session, and upon reaching the start time, automatically provide the sequential navigation directions on a navigation application to guide the user to each of the one or more suggested points of interest on the ordered list.
18. A tangible, non-transitory computer-readable medium storing instructions for providing an experience-focused navigation session, that when executed by one or more processors cause the one or more processors to: obtain user data corresponding to a user of the computing device and a current location of the user; determine a semantic mapping corresponding to the user based on one or more user preferences and a location history included in the user data; determine a suggested experience-focused navigation session for the user based on the semantic mapping and the current location of the user, wherein the suggested experience-focused navigation session includes an ordered list of one or more suggested points of interest; and automatically provide the suggested experience-focused navigation session to the user as a notification on the computing device.
19. The tangible, non-transitory computer-readable medium of aspect 18, wherein the user data corresponding to the user includes calendar data of the user, and the instructions, when executed by the one or more processors, further cause the one or more processors to: generate, by an experience learning model, proximity values that each correspond to an experience-focused navigation session of one or more experience-focused navigation sessions for the user based on the semantic mapping and the current location of the user, wherein the proximity values are based on the semantic mapping, the current location of the user, and the calendar data of the user; and automatically provide, by the one or more processors, the suggested experience-focused navigation session to the user as the appointment on a calendar application of the computing device.
20. The tangible, non-transitory computer-readable medium of any of aspects 18-19, wherein the suggested experience-focused navigation session includes (i) the ordered list of one or more suggested points of interest, (ii) sequential navigation directions to each suggested point of interest on the ordered list, and (iii) a start time, and the instructions, when executed by the one or more processors, further cause the one or more processors to: receive, by a user interface, an acceptance indication from the user to confirm acceptance of the suggested experience-focused navigation session; and upon reaching the start time, automatically provide the sequential navigation directions on a navigation application to guide the user to each of the one or more suggested points of interest on the ordered list.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for providing access to shared navigation sessions through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method in a computing device for providing an experience-focused navigation session, the method comprising:
obtaining, at one or more processors of the computing device, user data corresponding to a user of the computing device and a current location of the user;
determining, by the one or more processors, a semantic mapping corresponding to the user based on one or more user preferences and a location history included in the user data;
determining, by the one or more processors, a suggested experience-focused navigation session for the user based on the semantic mapping and the current location of the user, wherein the suggested experience-focused navigation session includes an ordered list of one or more suggested points of interest; and
automatically providing, by the one or more processors, the suggested experience-focused navigation session to the user as an appointment on the computing device.

2. The method of claim 1, further comprising:
generating, by an experience learning model, proximity values that each correspond to an experience-focused navigation session of one or more experience-focused navigation sessions for the user based on the semantic mapping and the current location of the user.

3. The method of claim 2, wherein the user data corresponding to the user includes calendar data of the user, and the method further comprises:
generating, by the experience learning model, the proximity values based on the semantic mapping, the current location of the user, and the calendar data of the user; and
automatically providing, by the one or more processors, the suggested experience-focused navigation session to the user as the appointment on a calendar application of the computing device.

4. The method of claim 2, wherein the experience learning model is a machine learning model trained using training semantic data and training location data as input to output proximity values corresponding to a plurality of experiences.

5. The method of claim 4, wherein the experience learning model is a long short-term memory (LS™) model.

6. The method of claim 2, further comprising:
receiving, at the one or more processors, user feedback corresponding to completion of at least a portion of the suggested experience-focused navigation session; and
training, by the one or more processors, the experience learning model with the user feedback.

7. The method of claim 1, wherein the suggested experience-focused navigation session includes (i) the ordered list of one or more suggested points of interest and (ii) sequential navigation directions to each suggested point of interest on the ordered list.

8. The method of claim 7, wherein the suggested experience-focused navigation session includes a start time, and the method further comprises:
receiving, at the one or more processors by a user interface of the computing device, an acceptance indication from the user to confirm acceptance of the suggested experience-focused navigation session; and
upon reaching the start time, automatically providing, by the one or more processors, the sequential navigation directions on a navigation application of the computing device to guide the user to each of the one or more suggested points of interest on the ordered list.

9. The method of claim 7, further comprising:
receiving, at the one or more processors, a quick read (QR) code scanned by the user at a first location; and
responsive to receiving the QR code, determining the suggested experience-focused navigation session, wherein the ordered list includes (i) at least a second location and (ii) the sequential navigation directions from the first location to the second location.

10. The method of claim 1, further comprising:
determining, by the one or more processors, one or more indications of satisfaction corresponding to the user not completing a portion of the suggested experience-focused navigation session, wherein the one or more indications of satisfaction includes (i) not visiting one or more of the one or more suggested points of interest, (ii) visiting an alternative point of interest instead of one of the one or more suggested points of interest, or (iii) receiving a denial indication from the user of the suggested experience-focused navigation session.

11. The method of claim 10, further comprising:
combining, by the one or more processors, each of the one or more indications of satisfaction into a satisfaction metric value; and
assigning, by the one or more processors, the satisfaction metric value to the suggested experience-focused navigation session.

12. The method of claim 1, wherein the one or more user preferences correspond to a purchase history of a user and the location history includes one or more locations visited by the user.

13. The method of claim 1, wherein the user data includes timing data comprising at least one of (i) time of year data, (ii) day of the week data, or (iii) time of day data.

14. The method of claim 1, further comprising:
tagging, by the one or more processors, the suggested experience-focused navigation session with one or more tags indicating a type of experience; and
uploading, by the one or more processors, the suggested experience-focused navigation session to a social media platform with the one or more tags to share the suggested experience-focused navigation session with other users.

15. A computing device for providing an experience-focused navigation session, the computing device comprising:
one or more processors; and
a non-transitory computer-readable memory coupled to the one or more processors and storing instructions thereon that, when executed by the one or more processors, cause the computing device to:
obtain user data corresponding to a user of the computing device and a current location of the user,
determine a semantic mapping corresponding to the user based on one or more user preferences and a location history included in the user data,
determine a suggested experience-focused navigation session for the user based on the semantic mapping and the current location of the user, wherein the suggested experience-focused navigation session includes an ordered list of one or more suggested points of interest, and
automatically provide the suggested experience-focused navigation session to the user as a notification on the computing device.

16. The computing device of claim 15, wherein the user data corresponding to the user includes calendar data of the user, and the instructions, when executed by the one or more processors, further cause the computing device to:
generate, by an experience learning model, proximity values that each correspond to an experience-focused navigation session of one or more experience-focused navigation sessions for the user based on the semantic mapping and the current location of the user, wherein the proximity values are based on the semantic mapping, the current location of the user, and the calendar data of the user, and
automatically provide, by the one or more processors, the suggested experience-focused navigation session to the user as the appointment on a calendar application of the computing device.

17. The computing device of claim 15, wherein the suggested experience-focused navigation session includes (i) the ordered list of one or more suggested points of interest, (ii) sequential navigation directions to each suggested point of interest on the ordered list, and (iii) a start time, and the instructions, when executed by the one or more processors, further cause the computing device to:
receive, by a user interface, an acceptance indication from the user to confirm acceptance of the suggested experience-focused navigation session, and
upon reaching the start time, automatically provide the sequential navigation directions on a navigation application to guide the user to each of the one or more suggested points of interest on the ordered list.

18. A tangible, non-transitory computer-readable medium storing instructions for providing an experience-focused navigation session, that when executed by one or more processors cause the one or more processors to:
obtain user data corresponding to a user of the computing device and a current location of the user;
determine a semantic mapping corresponding to the user based on one or more user preferences and a location history included in the user data;
determine a suggested experience-focused navigation session for the user based on the semantic mapping and the current location of the user, wherein the suggested experience-focused navigation session includes an ordered list of one or more suggested points of interest; and
automatically provide the suggested experience-focused navigation session to the user as a notification on the computing device.

19. The tangible, non-transitory computer-readable medium of claim 18, wherein the user data corresponding to the user includes calendar data of the user, and the instructions, when executed by the one or more processors, further cause the one or more processors to:
generate, by an experience learning model, proximity values that each correspond to an experience-focused navigation session of one or more experience-focused navigation sessions for the user based on the semantic mapping and the current location of the user, wherein the proximity values are based on the semantic mapping, the current location of the user, and the calendar data of the user; and
automatically provide, by the one or more processors, the suggested experience-focused navigation session to the user as the appointment on a calendar application of the computing device.

20. The tangible, non-transitory computer-readable medium of claim 18, wherein the suggested experience-focused navigation session includes (i) the ordered list of one or more suggested points of interest, (ii) sequential navigation directions to each suggested point of interest on the ordered list, and (iii) a start time, and the instructions, when executed by the one or more processors, further cause the one or more processors to:
receive, by a user interface, an acceptance indication from the user to confirm acceptance of the suggested experience-focused navigation session; and
upon reaching the start time, automatically provide the sequential navigation directions on a navigation application to guide the user to each of the one or more suggested points of interest on the ordered list.
